(19) United States
(12) Patent Application Publication
(10) Pub. No.: US 2003/0109261 A1
(43) Pub. Date: Jun. 12, 2003

(54) Method and apparatus for optimal rate (PHY mode) control in wireless modems with variable bit rate (VBR) capability

(76) Inventors: Javad Razavilar, San Diego, CA (US); Neeraj Poojary, San Diego, CA (US); Dennis P. Connors, San Diego, CA (US); James A. Crawford, San Diego, CA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/014,312

(22) Filed: Dec. 11, 2001

(51) Int. Cl. H04Q 7/20

(52) U.S. Cl. 455/452; 455/453

(57) ABSTRACT

A method of rate control between a first and second communication terminal supporting a plurality of data rates, the method including the steps of: receiving, at the second terminal, a signal transmitted at one of the rates from the first terminal via a forward channel; and determining an optimal one of the rates to be used by the first terminal for a subsequent signal to be transmitted to the second terminal based upon a maximization of the throughput to the second terminal given a channel state of the forward channel and a cost associated with a change in rate. In some variations, the method may be performed in the downlink of a system including the first terminal and multiple remote terminals. In some variations, the method is performed at the remote terminals in a distributed fashion.

### BACKGROUND OF THE INVENTION

1. Field of the Invention

The present invention relates generally to rate control in a communication system supporting multiple bit rates or data rates, and more specifically to a rate control algorithm for determining and controlling the rate used in a transmitter that communicates with the receiver. Even more specifically, the present invention relates to a rate control algorithm that may be used in the downlink of a wireless communication network in which a transmitter supporting multiple data rates communicates with multiple remote terminals.

2. Discussion of the Related Art

In any communication system there is a performance requirement in terms of target bit error rate (BER) that needs to be achieved for signaling received at a receiver. Usually the performance requirement for communication systems is defined as the target BER pₜ at the output of the system after all signal processing including all levels of forward-error-corrections (FEC) and automatic repeat request (ARQ) are completed.

In a communication system supporting multiple data rates by employing appropriate constellations with different coding rates, it is desirable to maximize system throughput or capacity. Throughput is a function of the signal-to-interference ratio (SIR) at a receiver and the modulation scheme used at a transmitter communicating with the receiver. Throughput may be defined as the number of bits that can be transmitted successfully to the receiver within each symbol. The more bits that are transmitted successfully within each symbol, the higher the throughput of the system. It is noted that as more bits are transmitted within each symbol, more transmit power is required for the bits to be successfully received within the required target BER at the receiver.

One technique to optimize throughput is to use adaptive modulation at a modulator of the transmitter to change the number of bits assigned to a carrier as channel conditions change, i.e., change the modulation depending on the channel conditions. The basic idea in adaptive modulation is to vary the number of bits assigned while meeting the required target BER. For example, in any given channel condition, it is desirable to transmit as many bits as possible while meeting the target BER. Thus, a rate control algorithm is employed by the communication system to control the data rate used at the transmitter and to control data rate switching based on the channel conditions.

In one approach, a determination whether the received bit error rate (BER) for signaling received at the receiver over a communication channel meets the required target BER at the output of the receiver is made. If the target BER is not met (e.g., the channel conditions are not favorable), then a decision is made to transmit subsequent frames at a lower data rate (e.g., transmit using QPSK rather than 16-QAM). If the target BER is met, then a decision is made to transmit subsequent frames using the same data rate. If the target BER is sufficiently exceeded (e.g., the channel conditions are favorable), then a decision is made to transmit at a higher rate (e.g., transmit using 64-QAM rather than 16-QAM). This decision may be made at the receiver and sent back to the transmitter or made at the transmitter itself based upon measurements sent back from the receiver.

In many communication systems, particularly wireless communication systems, the channel between a given transmitter and a given receiver may be time variant and unreliable; thus, there are fluctuations in the channel conditions at the receiver due to changes in the wireless channel characteristics. Often in wireless channels, particularly wireless channels in a multipath environment, such as in indoor wireless networks, the channel conditions deteriorate for a short period of time and then recover quickly. Disadvantageously, if the highest rate is selected based on different thresholds of the measured BER relative to the target BER and the channel conditions are fluctuating, a ping-pong effect may result where the system repeatedly switches between two rates. This results in an inefficient use of the system resources. Furthermore, unnecessary rate changes result in unnecessary changes in transmit power, which causes co-channel interference to other communication terminals, for example, within the indoor wireless network.

### SUMMARY OF THE INVENTION

The present invention advantageously addresses the needs above as well as other needs by providing an adaptive, real-time, optimal rate control algorithm with multi-rate capability that maximizes throughput while minimizes the number of unnecessary rate changes when selecting rates.

In one embodiment, the invention can be characterized as a method of rate control between a first communication terminal and one or more remote communication terminals of a communication system, and a means for accomplishing the method, the method including the steps of: receiving, at each of the one or more remote communication terminals, a respective signal modulated using a respective one of a plurality of rates from the first communication terminal via a respective forward channel, wherein each communication terminal is capable of supporting communications using the plurality of rates; and determining a respective optimal one of the plurality of rates to be used by the first communication terminal for a respective subsequent signal to be transmitted to each of the one or more remote communication terminals based upon a respective maximization of the throughput to each of the one or more remote communication terminals given a respective channel state of each respective forward channel and a cost associated with a change in rate.

In another embodiment, the invention may be characterized as a rate control device for controlling the rate for communications from a first communication terminal to a second communication terminal of a communication system, the device including a rate control module configured to perform the following steps: obtaining a respective one of a plurality of rates corresponding to a signal received over a forward channel from the first communication terminal, the received signal having been modulated using the respective one of the plurality of rates, wherein each communication terminal is capable of supporting communications using the plurality of rates; obtaining a channel state corresponding to the channel conditions of the forward channel for the signal received; and determining an optimal one of the plurality of rates to be used by the first communication terminal for a subsequent signal to be transmitted to the second communication terminal based upon a maximization of the throughput to the second communication terminal given the channel state of the forward channel and a cost associated with a change in rate.

In yet her embodiment, the invention can be characterized as a method of rate control between a first communication terminal and a second communication terminal of a communication system, the method including the following steps: obtaining a respective one of a plurality of rates corresponding to a signal received over a forward channel from the first communication terminal, the received signal having been modulated using the respective one of the plurality of rates, wherein each communication terminal is capable of supporting communications using the plurality of rates; obtaining a channel state corresponding to the channel conditions of the forward channel for the signal received; and determining an optimal one of the plurality of rates to be used by the first communication terminal for a subsequent signal to be transmitted to the second communication terminal based upon a maximization of the throughput to the second communication terminal given the channel state of the forward channel and a cost associated with a change in rate.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a diagram illustrating interference between communicating terminals of adjacent cells of a communication system;

FIG. 2 is a diagram illustrating one embodiment of a single cell of the communication system of FIG. 1;

FIG. 3 is a functional block diagram of several components of a remote terminal of the cell of FIG. 2, which according to several embodiments of the invention, implements a distributed rate control algorithm for downlink communications from the access point to the various remote terminals;

FIG. 4 is a flowchart illustrating the steps performed by a remote terminal of FIGS. 2 and 3 in implementing the distributed rate control algorithm for downlink communications from the access point to the remote terminal according to one embodiment of the invention;

FIG. 5 is a trellis diagram illustrating rate control algorithm updates for a given channel state according to one embodiment of the invention;

FIG. 6 is a flowchart illustrating one embodiment of the steps performed by the rate control module of a remote terminal of FIGS. 2 and 3 when implementing the optimal rate control algorithm of one embodiment of the invention;

FIG. 7 is a graph of transmitted bits per symbol versus range with and without the distributed downlink rate control algorithm of several embodiments of the invention;

FIGS. 8 and 9 are graphs of the error versus frame count in linear scale and logarithmic scale, respectively, illustrating the convergence of the distributed rate control algorithm of several embodiments of the invention; and

FIG. 10 is a flowchart illustrating one embodiment of the steps performed by the remote terminal of FIGS. 2 and 3 when implementing the optimal rate control algorithm of one embodiment of the invention.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

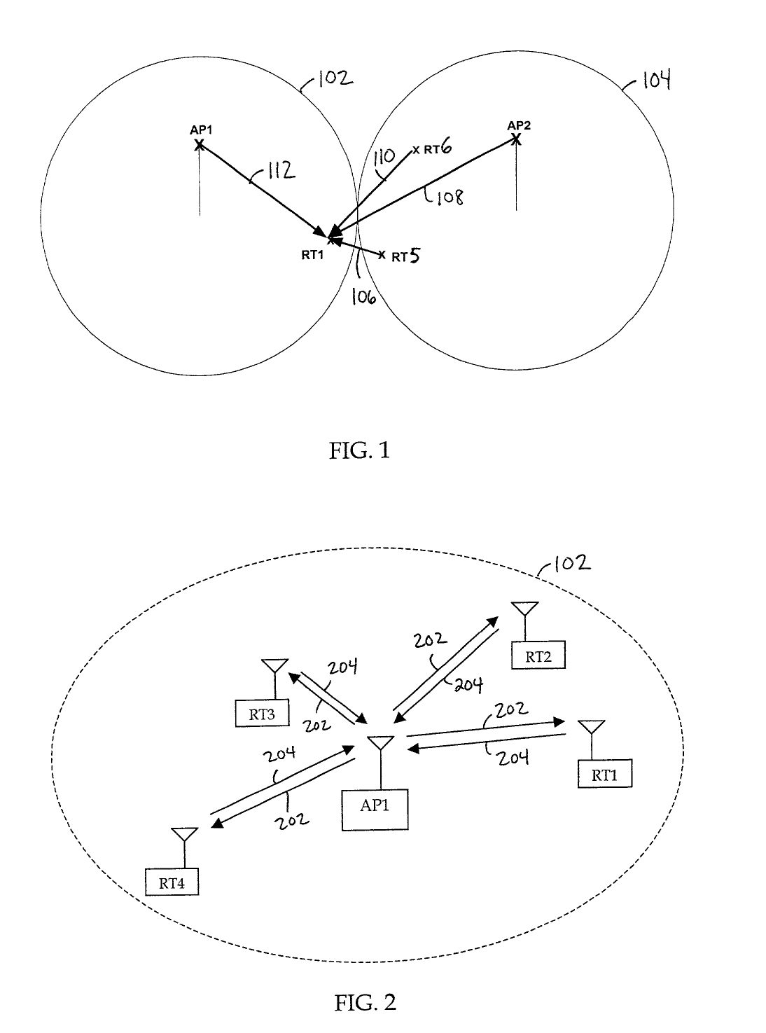

Referring first to FIG. 1, a diagram is shown illustrating interference between communicating terminals of adjacent cells of a communication system. Illustrated are two cells 102 and 104, cell 102 including access point 1 (AP1) and cell 104 including access point 2 (AP2). AP1 communicates with remote terminal 1 (RT1) in cell 102, while in cell 104, AP2 communicates with remote terminals 5 and 6 (RT5 and RT6).

Each access point, AP1 and AP2 share the same channel for uplink and downlink transmissions. Such a communication system, for example may comprise a wireless indoor network or a terrestrial cellular network. Focusing on the activity within cell 102, let AP1-RT1 denote a desired transmitter-receiver pair. Furthermore, in one embodiment, AP1 and RT1 transmit packets using a Time Division Multiple Access/Time Division Duplex (TDMA/TDD) scheme within cell 102; however, in other embodiments, AP1 and RT1 may communicate using any known multiplexing scheme. As is illustrated by arrows 106, 108 and 110, AP2, RT5 and RT6 in cell 104 cause interference during downlink/uplink transmissions in cell 102. During the downlink transmission 112 from AP1 To RT1 in cell 102, AP2 causes interference 108 during its downlink transmission destined for RT5 and RT6. Also RT5 and RT6 cause interference 106 and 110 on the downlink transmission in cell 102, during their uplink transmissions destined for AP2.

Now assume that N−1 different links or transmit-receive pairs in cell 104 cause interference in the downlink transmission 112 in cell 102. Let Gᵢⱼ denote the link gain from transmitter j (e.g., AP1) to receiver i (e.g., RT1), and Pⱼ denote the power of transmitter j. The link gain Gᵢⱼ is related to the path loss Lᵢⱼ. The path loss is proportional to dᵢⱼ^{k}, where k is the path loss exponent. Therefore, the path loss Lᵢⱼ in dB, assuming ideal free-space path loss with path loss exponent k=2, is given by:

Lᵢⱼ=20 log(4πdᵢⱼ/λ)+L_{σ} Eq. (1)

where dᵢⱼ is the distance between transmitter j and receiver i, λ=c/ƒ is the wavelength, and L_{σ} is a lognormal shadow fading with zero mean and variance σ, with σ=3˜8 dB. Now, the link gain Gᵢⱼ is given by:

Gᵢⱼ=10^{-L}^{ᵢⱼ}^{/10} Eq. (2)

It is noted that given the path loss (L), the noise floor (N₀), the transmit power (Pₜ), the modulation scheme, and the minimum detectable signal (MDS) at the receiver (receiver sensitivity), one can compute the range (distance between a transmit-receive pair) over which reliable communication is feasible. In this context, reliable communication means, achieving a minimum required signal-to-interference ratio (SIR) for a given constellation. This type of analysis is known as Link Budget Analysis. In this analysis, the noise floor is N=N₀BF, where N₀=−174 dBm/Hz and B is the receiver matched filter bandwidth in Hz (or noise bandwidth), and F is the receiver Noise Figure (NF) of 5 to 10 dB. For example, in some embodiments of a physical layer design, B=20 MHz. The received signal-to-interference ratio (SIR) defines the link budget:

$$γ = \frac{{P}_{r}}{N} = \frac{{E}_{s}}{{N}_{0}} \times \frac{{R}_{s}}{B} \qquad Eq . ( 3 )$$

Where Pᵣ is the received power, Eₛ is the symbol energy and Rₛ is the symbol rate. The receiver sensitivity S_{R} is defined as:

S_{R}=kT₀F(Eₛ/N₀)Rₛ Eq. (4)

where in equation (4) all variables are in linear scale, T₀ is the temperature equal to 290 K. Thus, the maximum allowable path loss, L_{max dB}, to achieve a specific link quality SIR as:

L_{max dB}=P_{t dB}−S_{R dB} Eq. (5)

In one embodiment, since the AP1 and RT1 are in a TDMA/TDD communication system, the interferers in cell 104, e.g., AP2, RT5 and RT6 do not all transmit at the same time. Therefore each transmission in cell 104 causes partial interference in a fraction of downlink transmission 112 in cell 102. Let αᵢⱼ∈{0,1}-valued random variable, which indicates that whether at the time of SIR measurement at receiver i (e.g., RT1) in cell 102, the transmitter with power Pⱼ in cell 104 affects the receiver i in cell 102. Cleary αᵢⱼ=1 and therefore, the power received at receiver i from transmitter j is

Pᵢⱼ=αᵢⱼGᵢⱼPⱼ, αᵢⱼ∈{0,1} Eq. (6)

Now the SIR for receiver i (e.g., RT1), denoted by γᵢ, is

$${γ}_{i} ( P ) = \frac{{G}_{ii} {p}_{i}}{{\sum }_{i \neq j} {α}_{ij} {G}_{ij} {p}_{j} + {N}_{i}} = \frac{{G}_{ii} {p}_{i}}{{I}_{i}} \qquad Eq . ( 7 )$$

where P=[p₁, p₂, . . . p_{N}], is the power vector and Nₜ is thermal noise at receiver i, and

$${I}_{i} = {\sum }_{i \neq j} {α}_{ij} {G}_{ij} {p}_{j} + {N}_{i} ,$$

is the total noise-plus-interference at receiver i. From Eq. (7), one can clearly see that in dynamic TDMA systems, the interference pattern can fluctuate more rapidly because of αᵢⱼ factors. Thus, the interference in cell 102 of the system of FIG. 1, for example, generated by the terminals of cell 104, causes fluctuations in the channel conditions as seen by the terminals of cell 102.

Referring next to FIG. 2, a diagram is shown illustrating one embodiment of a single cell of the communication system of FIG. 1. In this embodiment, the cell 102 includes access point 1 (AP1) and remote terminals 1, 2, 3 and 4 (RT1, RT2, RT3 and RT4). AP1 may generically be referred to as a communication terminal or a communication transceiver and includes a transmitter and receiver. Similarly, RT1, RT2, RT3 and RT4 may generically be referred to as remote communication terminals or remote transceivers, each including a transmitter and a receiver. The communication terminals of FIG. 2, e.g., AP1, RT1, RT2, RT3 and RT4, are configured to support multiple data rates, i.e., support multiple modulations such as M-QAM constellations. FIG. 2 also illustrates the forward channel 202 and the reverse channel 204 established between AP1 and each of RT1, RT2, RT3 and RT4. The forward channels 202 are also referred to as the downlink and the reverse channels 204 are also referred to as the uplink.

According to several embodiments of the invention, an optimal rate control algorithm is provided that adaptively controls the rate used by AP1 for communications over the forward channels (downlink) to each of RT1, RT2, RT3 and RT4. In preferred embodiments, the optimal rate control algorithm is a “distributed” algorithm in that the algorithm is performed at each of the remote terminals (which transmits rate update messages back to AP1) of the cell 102, rather than at a central controller for the entire communication system including other cells, e.g., cell 104 of FIG. 1. Thus, based upon signaling from AP1 that is received at each remote terminal (RT) and local measurements taken at each RT, each RT determines at what rate the AP1 should transmit at to each remote terminal for subsequent signaling to each RT over the downlinks depending on the channel conditions. Thus, in preferred embodiments, each remote terminal of each cell in the communication system individually attempts to optimize the rate for signaling transmitted from its access point to each remote terminal within the cell depending upon the channel conditions. Thus, the optimal rate control algorithm of several embodiments of the invention is performed locally within each cell without specific knowledge of the transmission activities and channel condition measurements in adjacent cells. The overall effect of all co-channel links in the system will be represented in the local SIR measurements, and in some embodiments, this is the only means that each terminal of a particular cell uses to learn about other terminals in the vicinity, as such the optimal rate control algorithm is distributed.

It is noted that in alternative embodiments, the optimal rate control algorithm may be centralized and performed in a central controller coupled to all cells in the system. In these alternate embodiments, local measurements of the channel conditions for the received signaling at each remote terminal are sent to the central controller (e.g., they are first forwarded to the access point, which then forwards them to a central controller. The central controller then determines what rate the access point of each cell should use for transmissions to each of its remote terminals to carry out the optimal rate control algorithm and then transmits these determinations back to the access point of each cell. However, in comparison to a distributed algorithm, the centralized optimal rate control algorithm takes up valuable bandwidth in receiving local measurements and transmitting the rate updates back to the respective cells of the system.

Furthermore, in some distributed embodiments, the optimal rate control algorithm is performed at each remote terminal and the rate update messages are then sent back to the access point from each remote terminal. In other embodiments, the optimal rate control algorithm is performed at the access point in that each of the remote terminals transmits the local measurements of the channel conditions for the signaling received over the downlink back to the access point and a controller at the access point determines what rate it should use for subsequent signaling to each remote terminal over the downlink.

As illustrated in FIG. 1, it is seen that the channel conditions on the respective forward channels will fluctuate due to the interference in neighboring cells and also due to changes in the multipath. In embodiments communciating using a TDMA/TDD frame structure, fluctuations in the channel conditions due to interference are increased. In preferred embodiments, the cell 102 of FIG. 2 represents an indoor wireless (or indoor/outdoor) local area network using orthogonal frequency divisional multiplexed (OFDM) communications based on the IEEE 802.11a standard or the HiperLAN2 standard. However, it is noted that the optimal rate control algorithms of several embodiments of the invention may be applied in communication systems utilizing any known single carrier or known multicarrier (one example of which is OFDM) transmission scheme. In some embodiments, the network is a residential network in which the access point is to another computer network, for example, a cable or satellite interface to an Internet, while the remote terminals comprise computers (PCs), laptops, televisions, stereos, appliances, palm devices, appliances, etc. In other embodiments, the network comprises a wireless local area network in an office or business in which the access point couples to a larger computer network and the remote terminals comprise other computers, laptops, palm devices, televisions, appliances, etc. It is understood that the optimal rate control algorithm of several embodiments of the invention may apply to any wireless communication network, e.g., cellular, satellite, optical, short range, long range, indoor/outdoor, having multi-rate capability in which channel conditions vary or fluctuate. It is noted that in many embodiments of the invention, one or more of the remote terminals support communications requiring different target bit error rates (BER), i.e., one or more of the remote terminals support traffic of different types of service (TOS). For example, one or more of the remote terminals RT1, RT2, RT3 and RT4 may support one or more of data, voice, and video traffic, for example.

It is also understood that the optimal rate control algorithm of several embodiments of the invention may be used between any two communicating devices, without requiring that such devices be a part of a network or a cell. Thus, the optimal rate control algorithm may be used in a system having two transceivers supporting multiple rates with forward and reverse channels established there between. Furthermore, it is understood that the optimal rate control algorithm of several embodiments may be used between a transmitter-receiver pair supporting multiple data rates, as long as there is a reverse channel of some type established between the transmitter and the receiver to transmit rate update messages in any known form back to the transmitter.

According to several embodiments of the invention, a signal or communication burst is transmitted, e.g., in a media access control (MAC) frame, from a transmitter (e.g., AP1) to a receiver (e.g., RT1). Based on the received signal, the receiver measures the channel conditions using an appropriate channel condition metric. In one embodiment, the receiver measures the signal-to-interference ratio (SIR) of the received signal. Next, the receiver determines what is the state of the channel based upon the measured channel condition metric, i.e., determines the channel state, which is used by the optimal rate control algorithm to determine the rate for the next signal or burst from the access point for that particular remote terminal. Generally speaking, in order to maximize the throughput between the transmitter and the receiver, during periods of good channel conditions, it is desired to transmit the signaling using the highest rate possible that will still meet the target BER at the receiver. Thus, more bits are successfully transmitted per symbol. During periods of poor channel conditions, a lower rate is chosen such that fewer bits are transmitted per symbol.

However, when rate switches occur frequently or ping-pong rapdily between two different rates, the system may become inefficient. In some cases, a slightly higher BER may be tolerated for a short period of time without having to switch the rate. Thus, according to several embodiments, the objective of the optimal rate control algorithm is to maximize the throughput (by choosing the largest constellation for each burst which satisfies the target BER) but at the same time minimize the number of unnecessary data rate switchings. This is in contrast to known systems, which simply select the highest data rate that will satisfy the target bit error rate at the receiver.

Generally, in a communication system, the user throughput is a function of the channel conditions, e.g., the received signal-to-interference ratio (SIR), and the modulation scheme. The user SIR is a function of the transmit power of all users in the system. The transmit powers of unwanted users (e.g., AP2, RT5 and RT6 in FIG. 1) cause interference and potentially can reduce the SIR for the desired user. By employing distributed power control techniques, this interference can be minimized or reduced to an acceptable level. Another method to improve throughput is to use adaptive modulation, i.e., change the modulation level or coding rate by adapting it to the channel condition. In accordance with several embodiments of the invention, in the downlink, fast power control techniques are not employed but slow power adjusting techniques may be employed; however, an optimal rate control algorithm is employed.

In any practical system, the number of bits transmitted within each symbol is restricted to a finite number of values. For example, when using an M-QAM modulation scheme, the constellation size is restricted to Mⱼ=2^{j}, j=1,2, . . . , J, making the bits per symbol equal to one of a small set of values. For the M-QAM modulation scheme, the throughput (spectral efficiency) is defined in terms of bits/Hz/subcarrier as follows:

Tⱼ(γ)=(1−p_{b,j}(γ))log₂(Mⱼ) Eq. (8)

where 0≦p_{b,j}≦1 is the uncoded BER (i.e., the BER at the output of a demodulator of the receiver) associated with j^{th} QAM constellation, γ is the SIR of the received signal and M is the constellation size. In the ideal case, it follows that:

$${2}^{b} - 1 = \frac{S}{N} \qquad Eq . ( 9 )$$

which means each extra bit, i.e. doubling constellation size, requires roughly an extra 3 dB increase in SNR (doubling the SNR in the linear scale). For example, BPSK requires about 3 dB, QPSK requires about 6 dB, 16-QAM requires about 12 dB, and 64-QAM requires about 18 dB.

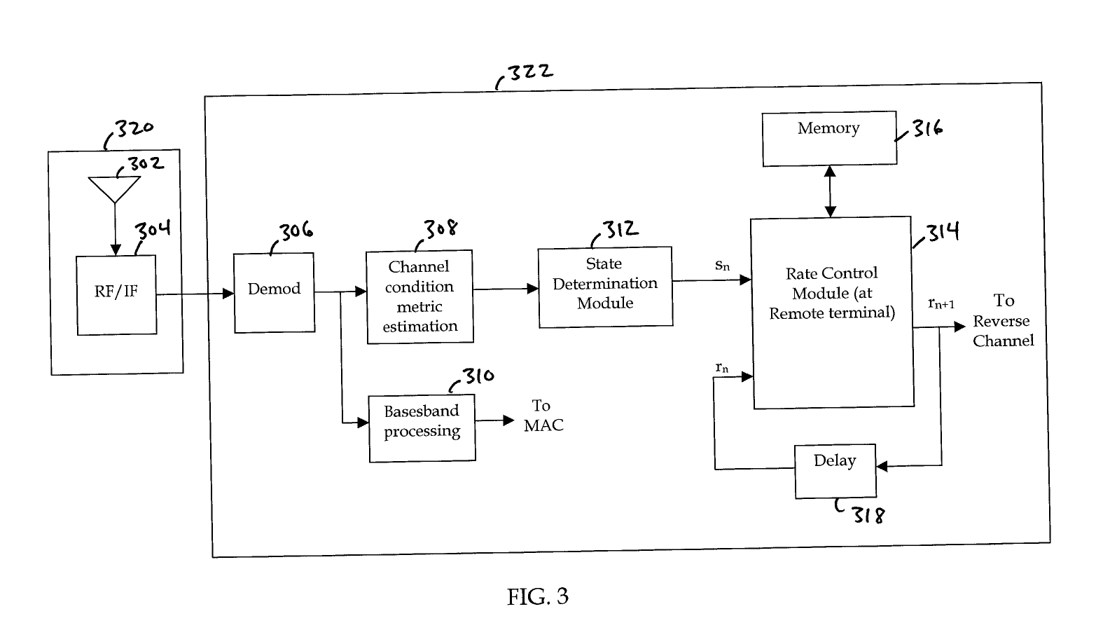

Referring next to FIG. 3, a functional block diagram is shown of several components of a remote terminal of the cell of FIG. 2, which according to several embodiments of the invention, implements a rate control algorithm for downlink communications from the access point to the remote terminal.

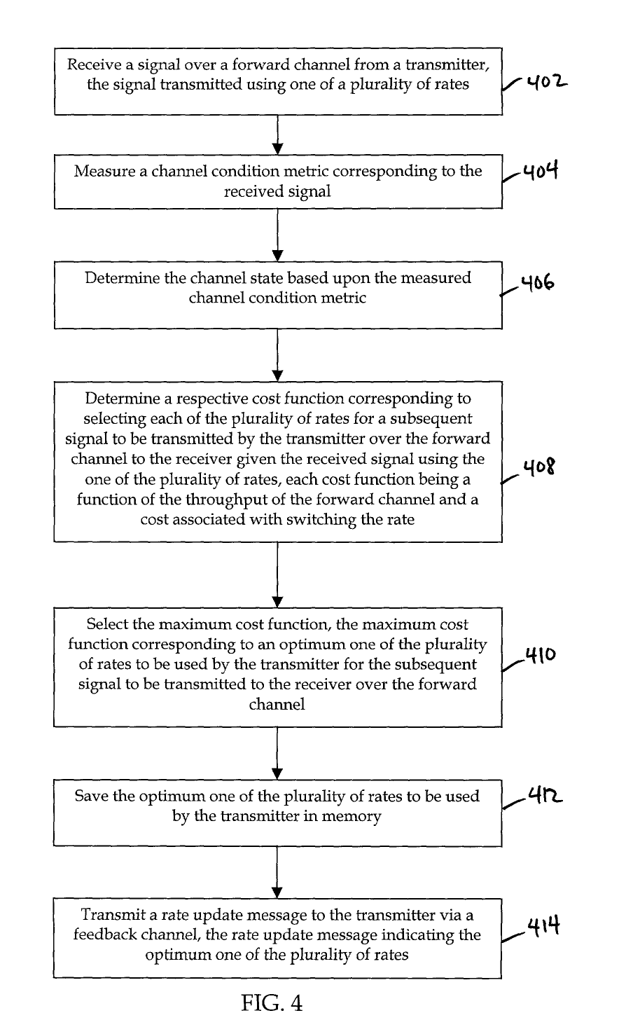

While referring to FIG. 3, concurrent reference will be made to FIG. 4, which is a flowchart illustrating the steps performed by a receiver, for example, a remote terminal of FIGS. 2 and 3, in implementing the distributed rate control algorithm for downlink communications from the access point to the remote terminal according to one embodiment of the invention.

Shown is an antenna 302, a radio frequency/intermediate frequency portion 304 (hereinafter referred to as the RF/IF portion 304), a demodulator 306, a channel condition metric estimation 308, a baseband processing portion 310, a state determination module 312, a rate control module 314, a memory 316 and a delay 318. Also illustrated is an RF/IF integrated circuit device 320 (also referred to as the RF/IF IC device 320) including the antenna 302 and the RF/IF portion 304 coupled to a baseband integrated circuit device 322 (also referred to as the baseband IC device 322) including the demodulator 306, the channel condition metric estimation 308, the baseband processing portion 310, the state determination module 312, the rate control module 314, the memory 316 and the delay 318.

In one embodiment, it is assumed that the transmit power of the transmitter communicating with the receiver is fixed. For example, in the system of FIG. 2, the transmit power for AP1 is fixed at a level P_{Tx}, i.e., there is no power control for the downlink direction. This is so that the access point, e.g., AP1, can communicate with any remote terminal within the physical boundaries of the cell. However, it is noted that power control algorithms may also be implemented along with the rate control algorithms of several embodiments of the invention. It is also assumed that the transmitter, e.g., AP1, is capable of transmitting packets for the receiver, e.g., each of RT1, RT2, RT3 and RT4, in the downlink with different bit rates, R₁<R₂< . . . <R_{J}, Rⱼ=log₂(Mⱼ), and Mⱼ=2^{j}, j=1,2, . . . , J, for example using an M-QAM modulation scheme (e.g., BPSK, QPSK, 16-QAM, 64-QAM, etc.). Each of these constellations may be differently encoded to produce more than J admissible rates or PHY modes. Furthermore, it is understood that the communications may be transmitted according to any known single carrier or multicarrier modulation.

The antenna 302 (e.g., at RT1) receives communications from a transmitter (e.g., AP1) over a forward channel (e.g., forward channel 202) and couples to the RF/IF portion 304. Thus, a signal (e.g., a signal or burst transmitted within a medium access control (MAC) frame) is received from the forward channel (Step 402 of FIG. 4), the signal being transmitted from a transmitter (e.g., AP1) using one of the available rates. It is noted that the received signal may be any communication burst from the transmitter. In some embodiments, the signal comprises a portion or burst transmitted within a MAC frame, one or more MAC frames, or other communication burst from the transmitter that is not part of a MAC frame structure or is asynchronously transmitted. It is noted that the channel conditions, e.g., the SIR of the received signal, at the receiver are subject to fluctuations due to changes in the wireless channel characteristics.

The signaling is downconverted from RF to IF and from IF to baseband at the RF/IF portion 304. Next, the signal is processed at the demodulator 306. It is noted that in preferred embodiments, each signal received is an OFDM signal, such that the demodulator 306 inlcudes a fast Fourier transform (FFT). The demodulated signal is then forwarded to the baseband processing portion 310 which outputs to the MAC layer.

In parallel to the baseband processing, a channel condition metric is obtained at the channel metric estimation (Step 404 of FIG. 4). In one embodiment, the signal-to-interference ratio (SIR) is measured for the signal received over the forward channel from the transmitter at the channel condition metric estimation 308; however, it is understood that other measurements reflecting the channel conditions may be performed, such as measuring the signal-to-noise ratio (SNR) or distortion level of the received signal. The received signal was transmitted using one of a finite set of available rates. In the case of a multicarrier signal, such as an OFDM signal, the channel condition metric is measured as an aggregate or average over the multiple subcarriers of the multicarrier waveform. It is also noted that in some embodiments, the channel conditions may be measured for each subcarrier of a multicarrier waveform. The channel condition metric estimation 308 process may be performed according to any well known techniques in the art. It is noted that although the channel condition metric estimation 308 is taken at baseband in this embodiment, in other embodiments the channel condition metric estimation 308 could occur at IF, as is well known in the art.

Next, the output of the channel condition metric estimation 308 is used by the state determination module 312 to determine what is the state of the channel for the signal received (Step 406 of FIG. 4). For example, let S={0,1, . . . , K−1} denote a finite set of K channel states. The range of the received signal-to-interference ratio (SIR) is partitioned into a finite number of intervals. The members of set S correspond to those partitions. Let Γ₀=0<Γ₁<Γ₂< . . . <Γ_{K}=∞ be the thresholds of the received SIR. In one embodiment, the receiver, e.g., RT1, constantly monitors the channel by measuring the received SIR for received signaling. In the n^{th} iteration of the optimal rate control algorithm, the channel is said to be in channel state s^{k} if the received SIR∈[Γₖ,Γₖ₊₁). Once the various thresholds defining each channel state are defined, the state determination module 312 is a simple comparator that compares the measured channel condition metric, e.g., SIR, with the predefined ranges to determine the state of the channel. In one embodiment of a packet-based transmission system, the channel condition metric is measured once during the entire packet transmission time of one RT. However, in other embodiments, the channel condition metric may be sampled more frequently. This would ultimately lead to a rate control algorithm that converges closer to an optimal solution by matching itself to the channel behavior; however, this requires over-sampling of the channel condition metric, e.g., SIR, resulting in more computations required at each RT while receiving its packets.

Once the state of the channel is determined (step 406 of FIG. 4), the channel state output, sₙ, is input to the rate control module 314 for the n^{th} iteration of the optimal rate control algorithm, where sₙ=s^{k}. The rate control module 314 implements the optimal rate control algorithm of several embodiments of the invention. The objective of the optimal rate control algorithm is to make a decision as to what rate should be used for a subsequent signal or burst, e.g., transmitted within a MAC frame, to the receiver based upon the measured channel conditions. The decision is made to maximize the throughput (by choosing the largest constellation for each burst which satisfies the target BER) but at the same time minimize the number of unnecessary data rate switchings. In order to accomplish this, a cost function is defined for selecting the appropriate rate for the next signal to be transmitted to the receiver.

Thus, according to one embodiment of the invention, cost functions are determined that correspond to selecting each of the available rates for the next or subsequent signal to be transmitted by the transmitter given that the current signal has been transmitted using one of the available rates, these cost functions are a function of the throughput over the forward channel given each of the available rates and a cost associated with a change in rate (Step 408 of FIG. 4). Thus, the rate control module 314 determines, given that the rate of the received signal rₙ=R₁ (where n is the iteration index and is also referred to as the signal count or in some embodiments, the frame count), what is the cost of staying at R₁, going to R₂, going to R₃ and going to rate R_{L} (where L is the total number of PHY modes) for the rate rₙ₊₁ for the next signal (the (n+1)^{th} signal, e.g., transmitted in the (n+1)^{th} MAC frame) which will be used in the (n+1)^{th} iteration of the optimal rate control algorithm. Next, the maximum cost function out of the cost functions is selected, the maximum cost function corresponds to the optimum one of the available rates to be used by the transmitter in the next signal to the receiver (Step 410 of FIG. 4). The optimum one of the available rates to be used for the next signal, i.e., rₙ₊₁, given the rate rₙ and channel state sₙ during the current received signal (e.g., the n^{th} signal or n^{th} iteration of the algorithm) is saved in memory 316 (Step 412 of FIG. 4). The following describes several embodiments of the cost functions employed by the rate control module 314 when implementing Steps 408 through 412 of FIG. 4.

According to one embodiment, a positive reward is assigned for selecting the largest possible constellation, e.g., M-QAM constellation, and a cost C (negative reward) is assigned for switching the rate. The rate control algorithm of several embodiments attempts to maximize this aggregate cost for the entire duration of a session between a given receiver (e.g., RT1) and a given transmitter (e.g., AP1). The positive reward encourages the receiver to select the highest rate, but the negative cost discourages the receiver from switching the rate. If decisions are made solely on the basis of the highest rate without any penalty for switching the rate, then a ping-pong effect may develop, where the receiver requests that the transmitter switch back and forth between two rates. Therefore, reducing the number of rate switchings is important, because in a wireless channel there are many occasions where the channel conditions deteriorate for a short time but might recover quickly right after that. Reacting to all channel fluctuations by changing the rate could be wasteful in terms of efficient use of system resources. On the other hand, if the rate switching decisions are put off too long by choosing C(C<0) too small, then the link quality may drop below acceptable levels before switching to the appropriate rate (i.e., procrastination in switching the rate is not good either). This may lead to involuntarily termination of the link in the middle of a session, which is undesirable and to be avoided. Therefore, the rate control algorithm of several embodiments attempts a balanced trade off between these two system parameters, i.e., maximizing throughput and minimizing unnecessary rate changes.

The rate control module 314 performs the rate control algorithm to decide what rate should be used at the transmitter for the (n+1)^{th} signal (rₙ₊₁) based on the channel state (sₙ) determined at the receiver and the rate (rₙ) used for the n^{th} signal. This decision is sent back to the transmitter (e.g., AP1) as a rate update message via the reverse channel (Step 414 of FIG. 4). Upon receiving this information in the reverse channel, the transmitter then adjusts its rate for the next signal (e.g., MAC burst) to be transmitted to the receiver. Measurements taken at the receiver are input to the rate control module 314 in order to make the decision. The process represents a closed loop rate control algorithm. The decision output from the rate control module 314 is illustrated as rₙ₊₁ in FIG. 3. Thus, a feedback channel is needed between the transmitter and receiver (e.g., reverse channel 204). In one embodiment, if there are L admissible rates or PHY modes in the system, then the reverse channel should be at least log₂L-bits long. Several embodiments of the optimal rate control algorithm are specifically designed for a dynamic TDMA/TDD scheme where the duty cycle of each traffic burst within a cell and the interfering terminal(s) from neighboring cells will change from frame to frame. This causes more severe fluctuations in the channel conditions, e.g., the received SIR levels. Memory 316 is coupled to the rate control module 314 to store the decision rₙ₊₁ of the algorithm. Furthermore, the output of the rate control module 314 is passed through a delay 318 such that the decision corresponding to the n^{th} frame, rₙ, is used as an input to the rate control module 314 to determine the rate for the (n+1)^{th} frame, rₙ₊₁.

Now let [sₙ, n=0,1, . . . ] be a discrete time process. At any given time the state of the channel sₙ takes its value from a finite state space denoted by the set of non-negative integers S={0, 1, . . . , K−1}. During the n^{th} iteration of the algorithm or the n^{th} received signal (e.g., MAC frame), for n=1,2, . . . , the channel is in channel state sₙ and the symbols are transmitted in the downlink using one of the L possible rates. For example, the L possible rates include J rates of an M-QAM modulation with rate Rⱼ=log₂(Mⱼ), j=1,2, . . . , J. Furthermore, each constellation may be encoded differently to effectively produce more admissible rates or PHY modes. For example, a listing of admissible rates may include BPSK, QPSK rate ½, QPSK rate ¾, 16-QAM rate ½, 16-QAM rate ¾, etc., for a total of L possible or admissible rates or PHY modes in the system.

Accordingly, a decision needs to be made so as to which rate to select for transmitting the packets in the downlink during the (n+1)^{th} signal, e.g., transmitted in the (n+1)^{th} MAC frame. Given that the decision at the output of the rate control module 314 rₙ₊₁ denotes the L-valued random variable which encodes the decision taken at time n, i.e., if rₙ₊₁=l, l=1, 2, . . . , L, then the rate that will be used during the (n+1)^{th} signal will be Rₗ, where l=1,2,3, . . . ,L.

Now, the aggregate two-dimensional state of the system or “system state” is defined as (sₙ, rₙ) which takes values in {0,1, . . . , K−1}×{1,2, . . . , L}. Thus, as illustrated in FIG. 3, the aggregate state of the system or system state is input to the rate control module 314. Suppose that for the (n+1)^{th} signal based on the n^{th} received signal, the receiver chooses rate u (which can be any of the L admissible rates) for rₙ₊₁ while the aggregate system state is (sₙ, rₙ). Then, an instantaneous cost-per-stage is incurred according to the following cost function:

$$R ( {s}_{n} , {r}_{n} , u ) = \{ \begin{matrix}T ( {r}_{n} , {s}_{n} ) & if & u = {r}_{n} \\ C + T ( u , {s}_{n} ) & if & u \neq {r}_{n}\end{matrix} \qquad Eq . ( 10 )$$

where T(rₙ, sₙ) is the throughput or capacity when rate rₙ (i.e., u=rₙ) is used for rₙ₊₁ while the channel is in channel state sₙ, T(u, sₙ) is the throughput when rate u is used for rₙ₊₁ while the channel is in channel state sₙ, and the cost C<0. Thus, according to Eq. (10), when the same rate is used for rₙ₊₁ of the subsequent signal (e.g., u=rₙ), the cost-per-stage function R(sₙ,rₙ,u) is the throughput using rate rₙ, and when a different rate is selected for rₙ₊₁ of the subsequent signal (e.g., u≠rₙ), the cost-per-stage function R(sₙ,rₙ,u) is the throughput using the different rate u for rₙ₊₁ plus a cost C associated with changing the rate from rₙ to u. It is noted that generally, the rate u (whether equal to rₙ or not) that is selected for rₙ₊₁ is the rate which provides the optimal or lowest overall cost, which is further described below.

It is noted that the throughput for rates rₙ and u in Eq. (10) may be determined in many ways. In preferred embodiments, the throughput for each of the available rates is measured given many different channel conditions (e.g., channel conditions coinciding with the channel states defined by the state determination module 312) in controlled tests. These values of the throughput of different rates during different channel conditions are stored in the receiver, e.g., within memory 316, and become the values of T(rₙ, sₙ) used in Eq. (10). In other embodiments, the throughput may be determined according to Eq. (8), using theoretical analysis.

The cost-per-stage function R(sₙ,rₙ,u) is a bounded mapping with R:{1,2, . . . ,K−1}×{1,2, . . . ,L}×{1,2, . . . ,L}→ [symbol] , where [symbol] denotes the set of real numbers. Let π(sₙ, rₙ), π:{0, . . . , K−1}×{1,2, . . . , L} [symbol] {1,2, . . . , L} be the optimal rate control policy, which provides the optimal rate rₙ₊₁ for the next signal or burst (e.g., MAC frame), given the initial condition (channel state sₙ and the rate rₙ). Given the evolution of the aggregate system state {(sₙ, rₙ), n=1,2, . . . , T}, where T is the number of signals (e.g., MAC frames) during the session, it is desired to determine the solution of the following maximization problem:

$${V}^{π} ( {s}_{0} , {r}_{0} ) = {max}_{u ∈ \{ 1 , 2 , , L \}} {E}_{{s}_{0} , {r}_{0}}^{π} [ {\sum }_{n = 0}^{T} {β}^{n} R ( {s}_{n} , {r}_{n} , u ) ] \qquad Eq . ( 11 )$$

where (s₀, r₀) is the initial system state, Eₛ_{₀}_{,r}_{₀}^{π} denotes the expectation under the optimal rate control policy π, 0<β≦1 is a discount factor, and R(sₙ,rₙ,u) is the cost-per-stage function during the n^{th} iteration as defined in Eq. (10). The above overall cost function V^{π}(s₀, r₀) reflects the fact that while choosing the rate rₙ₊₁ for the (n+1)^{th} signal (e.g., frame), the effect of this decision should be accounted for on the future behavior of the system. For the case where 0<β≦1, the use of the discount factor β is motivated by the fact that a cost to be incurred in the future is less important than one incurred at the present time instant. In other words, the rate control algorithm is interested in what effect a rate change will have in the next few subsequent signals (e.g., MAC frames), rather than what effect the rate change will have many signals in the future.

It is important to mention that the discount factor β also has a practical meaning in the system. A session between a transmitter and a receiver initiated at time n=0 will last a random number of T signals (e.g. T frames). As such, the probability that a given session is terminated in the current signal (MAC frame) is given as 1−β, and the probability that a session continues in next signal (MAC frame) is β. Consequently, session duration random variable T is geometrically distributed with

P[T=n+1]=(1−β)βⁿ Eq. (12)

In other words, the probability that the session duration to be T signals equal to n+1 is given by Eq. (12), where β is the discount factor.

Given the relationship in Eq. (12), and using the well-known theory of dynamic programming and the Bellman principle of optimality in mathematics (e.g., such as described in D. Bertsekas, “Dynamic Programming & Optimal Control”, Vol 2., Athena Scientific, 1995, pp. 2-12, which is incorporated herein by reference), the following equation provides an implicit equation that is satisfied by the optimal discounted cost function V(s, r) as stated in Eq. (11):

$${V}_{n} ( {s}_{n} , {r}_{n} ) - {max}_{u ∈ \{ 1 , 2 , … , L \}} \{ R ( {s}_{n} , {r}_{n} , u ) + β {V}_{n - 1} ( {s}_{n} , u ) \} \qquad Eq . ( 13 )$$

where R(sₙ,rₙ,u) is the cost-per-stage function as defined in Eq. (10), u assumes any possible value out of the L admissible rates for the rate rₙ₊₁, and rₙ₊₁ is the optimal one of the L rates to be used for the (n+1)^{th} signal and is given by:

$${r}_{n + 1} = {argmax}_{u} \{ R ( {s}_{n} , {r}_{n} , u ) + β {V}_{n - 1} ( {s}_{n} , u ) \} \qquad Eq . ( 14 )$$

where β(0<β≦1) is the discount factor, sₙ is the channel state during the n^{th} iteration (or equivalently the n^{th} received signal or MAC frame) of Eq. (13), rₙ is the rate of the current or n^{th} signal (e.g., during the n^{th} MAC frame) and rₙ₊₁ is the optimal rate to be used in the subsequent signal (i.e., (n+1)^{th} frame), L is the number of available rates, and n is the iteration index and is also referred to as the signal (or frame) count. Thus, Vₙ(sₙ, rₙ) provides the optimal solution to the Eq. (11) during the n^{th} iteration and depends on the solution of V(s,r) during the previous signal or iteration, which is shown as Vₙ₋₁(sₙ,u) in Eq. (13). Eq. (13) is iterated many times in order to determine the optimal discounted cost function Vₙ(sₙ, rₙ) given many different system states (i.e., many different combinations of channel states sₙ and current rates rₙ). Therefore, according to Eq. (14), the optimal rate rₙ₊₁ to be selected for the subsequent signal is the rate u (which may be any one of the L admissible rates) that maximizes or optimizes Eq. (13) depending on the channel state sₙ and rate rₙ (which is also one of the L admissible rates) of a currently received signal. Thus, solving Eq. (13) represents one embodiment of implementing Steps 408 and 410 of FIG. 4.

Thus, the optimal rate policy πₙ(sₙ, rₙ) for the n^{th} iteration provides the rate rₙ₊₁ to be used by the transmitter for the next signal, e.g., frame, to be transmitted to the receiver via the forward channel, which is the optimal solution of Eq. (13) and is given by Eq. (14).

Eqs. (13) and (14) provide an iterative algorithm to find the solution of the throughput maximization problem cast in Eq. (11). Eq. (13) represents a forward dynamic programming algorithm, similar to that known in the Viterbi decoding algorithm (maximum likelihood algorithm). According to Eq. (13), the cost function Vₙ(s,r) during iteration n depends on the calculation of Vₙ(s,r) during iteration n−1 and is represented by the term Vₙ₋₁(sₙ,u) in Eq. (14). Thus, the discounted cost function of iteration n is equal to a maximization of the cost function for the previous iteration discounted by β plus the cost-per-stage function R(sₙ,rₙ,u) over all possible values for u∈{1,2, . . . , L}. It is noted that initially (during the first iteration of Eq. (13)), the cost function Vₙ₋₁(s,r) is set to zero for all possible values of r and s.

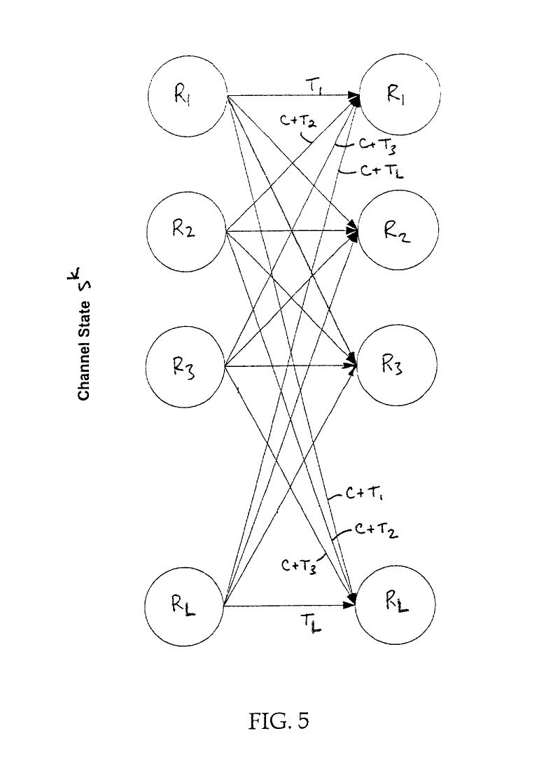

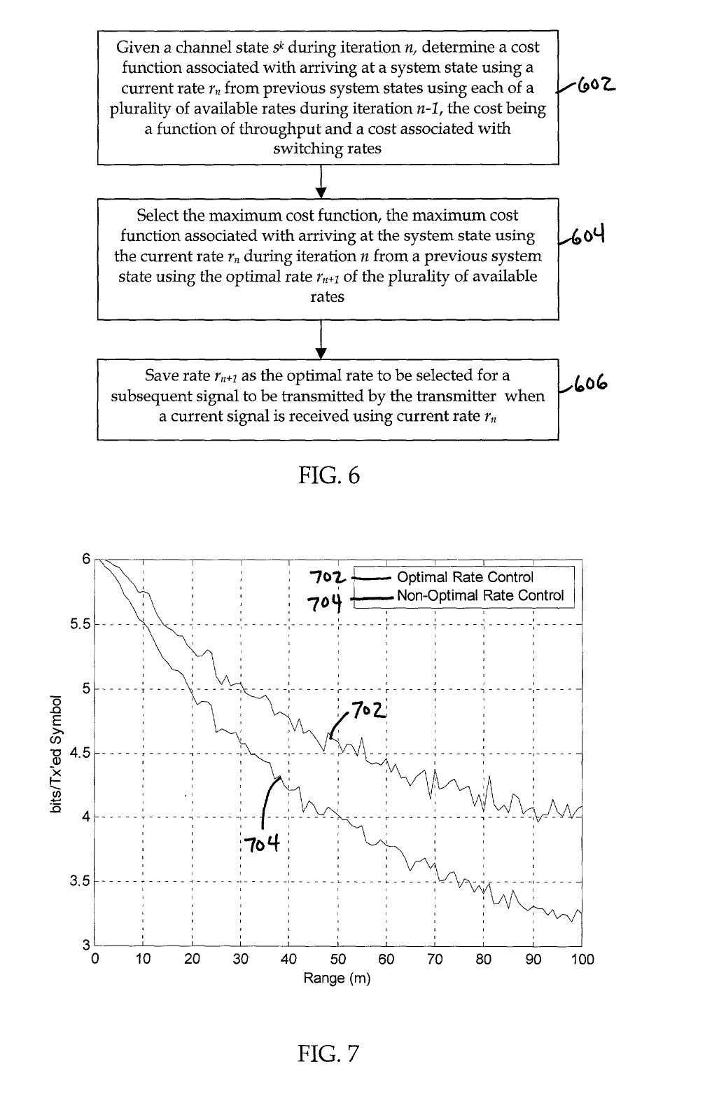

Referring next to FIG. 5, a trellis diagram is shown illustrating the rate control algorithm updates for a given channel state according to one embodiment of the invention. The trellis diagram of FIG. 6 represents an illustration of the maximization provided in Eq. (13) and Eq. (14).

While referring to FIG. 5, concurrent reference will also be made to FIG. 6, which is a flowchart illustrating the steps performed by a rate control module of a remote terminal of FIGS. 2 and 3 when implementing the optimal rate control algorithm of one embodiment of the invention. In one embodiment, the steps performed in FIG. 6 represent one embodiment of the steps performed to accomplish Steps 408 and 410 of FIG. 4.

Referring to the Trellis diagram, during a given iteration n of the optimal rate policy, by fixing the channel state S=s^{k} (where s^{k} is a member of set S={0, 1, . . . , K−1} defining a finite set of K channel states), and defining a new set of admissible rates Rₗ, l=1,2, . . . ,L, a remote terminal is said to be in system state (sₙ,rₙ) if the channel is in channel state sₙ when the n^{th} signal is transmitted and the rate Rₗ is used for the rate rₙ of the n^{th} signal transmitted from the transmitter (i.e., n also refers to the iteration count of the optimal power control algorithm). Thus, FIG. 5 shows stages of the trellis diagram derived by fixing the channel state at S=s^{k}. It is noted that this Trellis diagram represents only one of K channel states (i.e., channel state s^{k}), thus, a separate trellis diagram is to be constructed for each of the K channel states. The Trellis diagram illustrates various system states (s^{k},r) during iterations n and n−1 of Eq. (13), where s^{k} is the measured channel state (s^{k} being a member of set S) and rates Rₗ are the rates rₙ for the n^{th} signal transmitted (e.g., in the n^{th} frame).

Furthermore, it is noted that in one embodiment, the system states on the right side of the Trellis (illustrated as R₁ through R_{L}) represent the system state (s,r) during the n^{th} iteration (i.e., (s^{k},rₙ)), while the system states on the left column of the Trellis (illustrates as R₁ through R_{L}) represent the system state (s^{k},r) during iteration n−1 (i.e., (s^{k},rₙ₋₁)). In this embodiment, iteration n is assumed to correspond to the optimization or maximization performed on the current received signal or MAC frame (e.g., using Eq. (13)), while iteration n−1 corresponds to optimization performed on the previous signal or MAC frame.

According to several embodiments of the invention, for all branches of the Trellis arriving in one of the trellis system states, the path metrics or cost functions using Eq. (13) are computed. For example, if the remote terminal is determined to be in channel state s^{k} during iteration n (e.g., by the state determination module 312) and the current rate is rₙ=R₁ (corresponding to the stage R₁ on the right column of the trellis diagram), Eq. (13) is used to determine the respective cost functions for each path arriving at system state R₁ from the various previous system states R₁ through R_{L} on the left side of the trellis diagram during iteration n−1 (Step 602 of FIG. 6). Again, each of these cost functions is a function of the throughput and a cost associated with switching the rate. Of these paths, the maximum cost function is selected which corresponds to the maximized cost associated with arriving at a particular system state of the trellis (Step 604 of FIG. 6).

As is illustrated in the trellis diagram, for the given iteration n, the cost-per-stage function R(sₙ,1,1) for arriving at system state R₁ from system state R₁ is T₁, R(sₙ,1,2) for arriving at system state R₁ from system state R2 is C+T₂, R(sₙ,1,3) for arriving at system state R₁ from system state R₃ is C+T₃ and the R(sₙ,1,L) for arriving at system state R₁ from system state R_{L} is C+T_{L}. Thus, according to one embodiment, Eq. (13) is solved for each of the paths arriving at stage R₁ on the right side of the diagram, i.e., {R(sₙ,1,1)+βVₙ₋₁(sₙ,1)}, {R(sₙ,1,2)+βVₙ₋₁(sₙ,2)}, {R(sₙ,1,3)+βVₙ₋₁(sₙ,3)}, and {R(sₙ,1,L)+βVₙ₋₁(sₙ,L)}, where sₙ=s^{k} and the maximum path is selected. Again, during the first iteration, Vₙ₋₁(s,r) is set to zero for all values of s and r. For example, assume that the result of Eq. (13) yields that the path arriving at system state R₁ (at iteration n) from system state R₂ (at iteration n−1) is the maximum cost function. Thus, in a forward dynamic programming manner, this means that the algorithm has gone back to iteration n−1 and determined what is the cost function of going forward to the present system state at iteration n (in this example, R₁). In this embodiment, the cost to arrive at a current system state using rate rₙ from a previous system state using rate x in the trellis corresponds to the cost to go from the current system state using rate rₙ to subsequent system state at rate x, where x becomes the decision rₙ₊₁ of the rate control module 314, which may or may not be equal to rₙ. Thus, if the maximum path yielded by Eq. (13) and Eq. (14) indicates that the optimum or maximum rate change to system state R₁ is from system state R₂, then given that the system receives signaling at rₙ=R₁, then the optimal rate for the next signal is rₙ₊₁=R2. As such, the optimal rate rₙ₊₁ is saved as the rate for the subsequent signal (e.g., to be transmitted in the next frame) to be transmitted to the receiver by the transmitter (Step 606 of FIG. 6). Thus, the rate control module 314 will instruct the transmitter to use R₂ as the rate during the next signal. Only the trellis path arriving at system state R₁ from system state R₂ is saved in memory and all other branches arriving at system state R₁ will be discarded. Thus, knowing that the maximum path to arrive to system state R₁ is from system state R₂, anytime the receiver is in channel state s^{k}, and the current rate rₙ is R₁ (i.e., rₙ=R₁), the receiver will instruct the transmitter to use R₂ for the next signal (i.e., rₙ₊₁=R₂). Again, the system states in the right hand column of the trellis represent the state (s,r) of the system at channel state s^{k} and current rate r for the n^{th} iteration. The system states in the left hand column represent the state (s,r) of the system at channel state s^{k} and for the rate during iteration n−1, which once optimized, represents the rate rₙ₊₁ for the next signal. It is noted that in alternate embodiments, the cost function may be determined as a maximized cost to go from a current system state to each of several subsequent system states each having a different one of the available rates, rather than a cost to arrive at the present system state using the present rate from a previous system state using each of the available rates.

The process described above to determine the maximum path or maximum cost function for a given rate r is basically one iteration for updating Vₙ(s, r), in Eq. (13), for a given channel state s^{k}. This procedure will be repeated for all other system states of the trellis in other iterations, i.e., the process is repeated to find the maximum path metric according to Eq. (13) and Eq. (14) for the paths entering each system state (illustrated as R₁ through R_{L}) on the right side of the trellis and that maximum path will be stored in memory. Furthermore, the process is repeated for all K channel states, i.e., a separate Trellis diagram is generated for each of the K channel states. By translating the iterative algorithm represented by Eq. (13) into a Trellis diagram for each channel state, it becomes much easier to understand. Thus, in one embodiment, the receiver creates K (equal to number of channel states s^{k}, where k=0,1,2, . . . ,K−1) trellis diagrams similar to the one described in FIG. 6, but only needs to keep one stage of the trellis per rate on the right side of the trellis. Therefore, if there are K channels states and L different rates, then receiver needs KL memory locations to keep the previous values of the K trellis diagrams (L rates per trellis diagram). But the receiver only needs to update L of those memory locations associated with the channel state for the current signal or MAC burst measurement. In some embodiments, the number of operations to update those L memory locations will be L². For most practical cases of interest L² is not a big number and this will not be computationally a burden for most receivers.

The unique way in which the optimal rate control algorithm is interpreted, in terms of updating a trellis diagram in an iterative manner, provides an adaptive, real-time rate control algorithm for a general communication system.

It is noted that the steps listed in FIGS. 4 and 6 generally represent the steps performed by the rate control module in performing the optimal rate control algorithm according to several embodiments of the invention. These steps may be performed may be performed by the optimal rate control module 314 of FIG. 3 and/or may be performed as a set of instructions that are performed in dedicated hardware or in software using a processor or other machine to execute the instructions to accomplish the given steps.

Referring next to FIGS. 7-9 represent simulation results of an optimal rate control algorithm in the downlink of a communication system, such as shown in FIG. 3.

FIG. 7 illustrates a graph of transmitted bits per symbol versus range with and without the distributed downlink rate control algorithm of several embodiments of the invention. Line 702 illustrates the simulation results using an optimal rate control algorithm in the downlink while line 704 illustrates a system not using the optimal rate control algorithm in the downlink. FIG. 7 confirms that the downlink optimal rate control algorithm according to several embodiments of the invention is superior to the non-optimal rate control algorithm over the entire range. In this simulation, it has been assumed that the system uses forward error correction (FEC) and automatic repeat request (ARQ) at the MAC layer. This is a robust link is obtained for a wide range of distance between the remote terminals and the AP. As illustrated, the optimal rate control algorithm becomes more effective as the RTs get closer to the cell boundaries, i.e., as the range is increased. This effectiveness comes at a cost, which is more complexity compared to the non-optimal approach; however, in most cases this complexity is not high and can be handled easily.

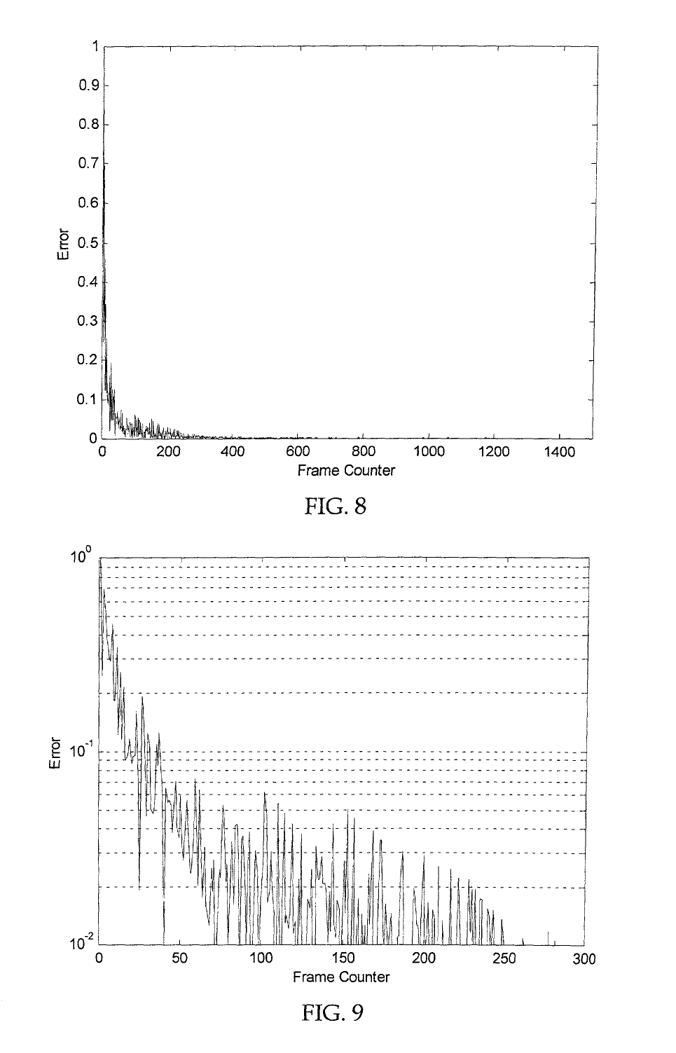

An important factor for the optimal adaptive rate control algorithm according to several embodiments is its convergence rate. FIGS. 8 and 9 are graphs of the error versus frame count in linear scale and logarithmic scale, respectively, illustrating the convergence of the distributed rate control algorithm of several embodiments of the invention. Convergence typically occurs when most of the maximum path metrics or cost functions for each channel state K are determined and stored, i.e., the maximum paths are determined for each of the rates in each of the K Trellis diagrams. In FIGS. 8 and 9, the error term eₙ for the optimal rate control algorithm is demonstrated and is given by:

eₙ=∥Vₙ(s,r)−Vₙ₋₁(s,r)∥ Eq. (15)

where Vₙ(s,r) is given by Eq. (13). The error term eₙ can be easily updated in each iteration of updating the trellis diagram for the optimal rate control algorithm. In terms of Eq. (15), convergence occurs when eₙ becomes small. In order to show that our algorithm converges very fast, the error term is displayed in a logarithmic scale in FIG. 9. This figure shows that with only 50 iterations the error term is less than 4%.

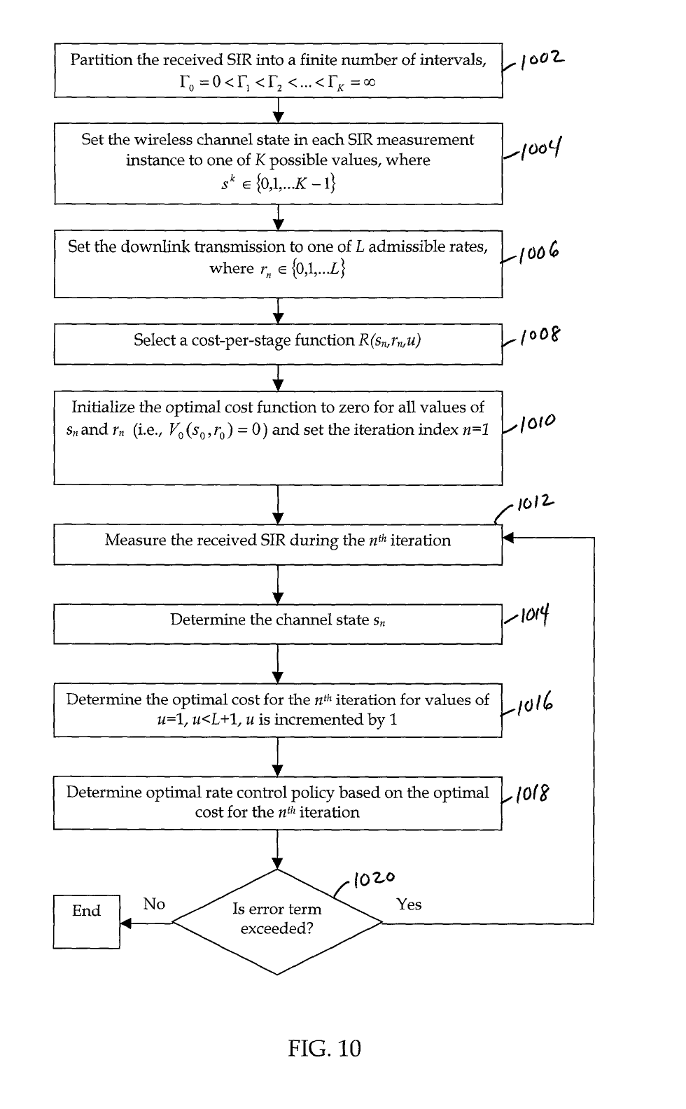

Referring next to FIG. 10, a flowchart is shown that illustrates one embodiment of the steps performed by the remote terminal of FIGS. 2 and 3 when implementing the optimal rate control algorithm of one embodiment of the invention.

Steps 1002 through 1010 represent several preliminary steps to initialize the system in order to perform the optimal rate control algorithm of several embodiments of the invention. In one embodiment, the received SIR is partitioned into a finite number of intervals, e.g., Γ₀=0<Γ₁<Γ₂< . . . <Γ_{K}=∞ (Step 1002). This is such that the channel state of the received signaling can be determined. Next, the wireless channel state is set for each SIR measurement instance, such that the wireless channel can only be in one of K+1 possible states s^{k}, where k∈{0,1, . . . K−1} (Step 1004). Next, the downlink transmission rate is set for each remote terminal to one of L admissible rates Rₗ, where rₙ∈{0,1, . . . L} (Step 1006). Next, a cost-per-stage function R(sₙ,rₙ,u) is selected, such as given in Eq. (10) (Step 1008). Next, initialize the optimal cost function V₀(s₀,r₀) (e.g., as given in Eq. (13)) is initialized to zero for all possible values of the channel state sₙ and rate rₙ, and the iteration index n is set equal to one (Step 1010).

Next, in operation, the channel condition metric is measured, e.g., the received SIR, during the n^{th} iteration (Step 1012) and the channel state sₙ is determined (Step 1014), where sₙ=s^{k}. Next, for values of u from 1 to L+1 in increments of 1, determine the optimal cost function Vₙ(s,r) for the n^{th} iteration (Step 1016). In one embodiment, Step 1016 is performed using Eq. (13). Next, the optimal rate control policy rₙ₊₁ is determined based on the determined optimal cost function (Step 1018), such as shown in Eq. (14) according to one embodiment.

In one embodiment, Step 1012 through Step 1018 are generally performed until the optimal rate control algorithm converges, i.e., until the error term provided in Eq. (15) becomes sufficiently small. This means that the optimal path or cost function has been determined for most of the channel states and most available rates. The convergence is illustrated in FIGS. 8 and 9. Thus, next, the rate control module determines if the error term has been exceeded (Step 1020), e.g., is ∥Vₙ(s,r)−Vₙ₋₁(s,r)∥>eₙ, where eₙ is defined by the system. If the error term is exceeded, Steps 1012 through Step 1018 are repeated for more values of s and r. If the error term is not exceeded, then the rate control algorithm is done, since it already has determined the optimal rates to use given the channel state s and the available rates for rₙ. It is noted that each of the remote terminals will continue to instruct the appropriate transmitter to select the optimal rate, but that the process of updating the Trellis diagrams and computing Eq. (13) and Eq. (14) is completed.

It is noted that the steps of FIG. 10 represents the steps performed in implementing the optimal rate control algorithm of several embodiments of the invention. In preferred embodiments, Steps 1002, 1004, 1108, 1010, 1016, 1018 and 1020 are performed at the receiver; however, these steps may also be performed at the transmitter or other central controller. In other embodiments, Steps 1016 and 1018 are performed by the rate control module of FIG. 3. In most embodiments, it is generally only necessary that Step 1012 be performed at the receiver; however, even Step 1012 may be performed remote to the receiver. For example, according to one embodiment, the rate control module of FIG. 3 performs Steps 1002, 1004 and 1008 through 1020. It is also noted that these steps may be performed as a set of instructions that are performed in dedicated hardware, firmware or in software using a processor or other machine to execute the instructions to accomplish the given steps.

While the invention herein disclosed has been described by means of specific embodiments and applications thereof, numerous modifications and variations could be made thereto by those skilled in the art without departing from the scope of the invention set forth in the claims.

What is claimed is:

1. A method of rate control between a first communication terminal and one or more remote communication terminals of a communication system, the method comprising:
receiving, at each of the one or more remote communication terminals, a respective signal modulated using a respective one of a plurality of rates from the first communication terminal via a respective forward channel, wherein each communication terminal is capable of supporting communications using the plurality of rates; and
determining a respective optimal one of the plurality of rates to be used by the first communication terminal for a respective subsequent signal to be transmitted to each of the one or more remote communication terminals based upon a respective maximization of the throughput to each of the one or more remote communication terminals given a respective channel state of each respective forward channel and a cost associated with a change in rate.

2. The method of claim 1 wherein the determining step comprises:
determining, for each determining the respective optimal one step, respective cost functions corresponding to selecting each of the plurality of rates for the respective subsequent signal given the respective received signal using the respective one of the plurality of rates, each of the respective cost functions being a function of the throughput to a respective one of each of the one or more remote communication terminals and a cost associated with the change in rate; and
selecting, for each determining the respective optimal one step, a respective optimal cost function from the respective cost functions, the respective optimal cost function providing the respective optimal one of the plurality of rates to be used by the first communication terminal for the respective subsequent signal to be transmitted by the first communication terminal.

3. The method of claim 2 wherein the determining, for each of the determining the respective optimal one step, the respective cost functions step comprises:
determining, for each of the determining the respective optimal one step, respective cost functions associated with arriving at a system state using the respective one of the plurality of rates from previous system states using each of the plurality of rates, each of the respective cost functions being a function of the throughput to a respective one of each of the one or more remote communication terminals and the cost associated with the change in rate;
wherein the selecting, for each determining the respective optimal one step, the respective optimal cost function comprises:
selecting, for each determining the respective optimal one step, the respective optimal cost function from the respective cost functions, the respective optimal cost function providing an optimal one of the plurality of rates used in arriving to the system state using the respective one of the plurality of rates; and
equating the optimal one of the plurality of rates used in arriving to the system state to the respective optimal one of the plurality of rates to be used by the first communication terminal for the subsequent signal.

4. The method of claim 2 further comprising solving, for each of the one or more remote communication terminals, the following equation to perform the determining, for each determining the respective optimal one step, the respective cost function step and the selecting, for each determining the respective optimal one step, the optimal cost function step:
$${V}_{n} ( {s}_{n} , {r}_{n} ) = {max}_{u ∈ \{ 1 , 2 , … , L \}} \{ R ( {s}_{n} , {r}_{n} , u ) + β {V}_{n - 1} ( {s}_{n} , u ) \}$$
where Vₙ(sₙ,rₙ) is the respective optimal cost function for the n^{th} iteration, sₙ is a current channel state of the respective forward channel corresponding to the respective received signal, rₙ is the respective one of the plurality of L rates that the respective received signal is modulated with, u assumes any possible value of the plurality of L rates for the rate rₙ₊₁, rₙ₊₁ is the respective optimal one of the plurality of L rates to be used by the first communication terminal for the respective subsequent signal, β is a discount factor, Vₙ₋₁(sₙ,u) is the respective optimal cost function for iteration n−1, and R(sₙ,rₙ,u) is a cost-per-stage function given by:
$$R ( {s}_{n} , {r}_{n} , u ) = \{ \begin{matrix}T ( {r}_{n} , {s}_{n} ) & if & u = {r}_{n} \\ C + T ( u , {s}_{n} ) & if & u \neq {r}_{n}\end{matrix}$$
where T(rₙ,sₙ) is the throughput to a respective one of the one or more remote communication terminals when rate rₙ is used for rₙ₊₁ given channel state sₙ, T(u,sₙ) is the throughput to the respective one of the one or more remote communication terminals when rate u is used for rₙ₊₁ given channel state sₙ, and C is the cost associated with the change in rate, where C<0.

5. The method of claim 4 further comprising selecting the rate rₙ₊₁ that satisfies the respective optimal cost function for each of the one or more remote communication terminals as the respective optimal one of the plurality of rates to be used by the first communication terminal for the respective subsequent signal, where rₙ₊₁ is given by:
$${r}_{n + 1} = {argmax}_{u} \{ R ( {s}_{n} , {r}_{n} , u ) + β {V}_{n - 1} ( {s}_{n} , u ) \} .$$

6. The method of claim 1 further comprising establishing the respective forward channel and a respective reverse channel between the first communication terminal and each of the one or more remote communication terminals.

7. The method of claim 1 further comprising determining the respective channel state of the respective forward channel between the first communication terminal and each of the one or more remote communication terminals, the respective channel state based upon a respective measured signal-to-interference ratio corresponding to the respective received signal.

8. The method of claim 1 further comprising transmitting a respective rate update message to the first communication terminal from each of the one or more remote communication terminals, each respective rate update message indicating the respective optimal one of the plurality of rates to be used by the first communication terminal for the respective subsequent signal.

9. The method of claim 1 further comprising saving the respective optimal one of the plurality of rates to be used by the first communication terminal for the respective subsequent signal in memory.

10. The method of claim 1 wherein the determining step is performed at each of the one or more remote communication terminals.

11. A rate control device for controlling the rate for communications from a first communication terminal to a second communication terminal of a communication system comprising:
a rate control module configured to perform the following steps:
obtaining a respective one of a plurality of rates corresponding to a signal received over a forward channel from the first communication terminal, the received signal having been modulated using the respective one of the plurality of rates, wherein each communication terminal is capable of supporting communications using the plurality of rates;
obtaining a channel state corresponding to the channel conditions of the forward channel for the signal received; and
determining an optimal one of the plurality of rates to be used by the first communication terminal for a subsequent signal to be transmitted to the second communication terminal based upon a maximization of the throughput to the second communication terminal given the channel state of the forward channel and a cost associated with a change in rate.

12. The device of claim 11 further comprising an integrated circuit device, the rate control module implemented within the integrated circuit device.

13. The device of claim 11 wherein the determining step to be performed by the rate control module comprises:
determining, for the determining the optimal one step, cost functions corresponding to selecting each of the plurality of rates for the subsequent signal given the received signal using the respective one of the plurality of rates, each of the cost functions being a function of the throughput to the second communication terminal and a cost associated with the change in rate; and
selecting, for the determining the optimal one step, an optimal cost function from the cost functions, the optimal cost function providing the optimal one of the plurality of rates to be used by the first communication terminal for the subsequent signal to be transmitted by the first communication terminal.

14. The device of claim 13 wherein the determining, for the determining the optimal one step, the cost functions step to be performed by the rate control module comprises:
determining, for the determining the optimal one step, cost functions associated with arriving at a system state using the respective one of the plurality of rates from previous system states using each of the plurality of rates, each of the cost functions being a function of the throughput to the second remote communication terminal and the cost associated with the change in rate; and
wherein the selecting, for the determining the optimal one step, the optimal cost function comprises:
selecting, for the determining the optimal one step, the optimal cost function from the cost functions, the optimal cost function providing an optimal one of the plurality of rates used in arriving to the system state using the respective one of the plurality of rates; and
equating the optimal one of the plurality of rates used in arriving to the system state to the optimal one of the plurality of rates to be used by the first communication terminal for the subsequent signal.

15. The device of claim 13 wherein the rate control module is configured to perform the following additional step:
solving the following equation to perform the determining, for the determining the optimal one step, the cost function step and the selecting, for the determining the optimal one step, the optimal cost function step:
$${V}_{n} ( {s}_{n} , {r}_{n} ) = {max}_{u ∈ \{ 1 , 2 , … , L \}} \{ R ( {s}_{n} , {r}_{n} , u ) + β {V}_{n - 1} ( {s}_{n} , u ) \}$$
where Vₙ(sₙ,rₙ) is the optimal cost function for the n^{th} iteration, sₙ is a current channel state of the forward channel corresponding to the received signal, rₙ is the respective one of the plurality of L rates that the received signal is modulated with, u assumes any possible value of the plurality of L rates for the rate rₙ₊₁, rₙ₊₁ is the optimal one of the plurality of L rates to be used by the first communication terminal for the subsequent signal, β is a discount factor, Vₙ₋₁(sₙ,u) is the optimal cost function for iteration n−1, and R(sₙ,rₙ,u) is a cost-per-stage function given by:
$$R ( {s}_{n} , {r}_{n} , u ) = \{ \begin{matrix}T ( {r}_{n} , {s}_{n} ) & if & u = {r}_{n} \\ C + T ( u , {s}_{n} ) & if & u \neq {r}_{n}\end{matrix}$$
where T(rₙ,sₙ) is the throughput to the second communication terminal when rate rₙ is used for rₙ₊₁ given channel state sₙ, T(u,sₙ) is the throughput to the second communication terminal when rate u is used for rₙ₊₁ given channel state sₙ, and C is the cost associated with the change in rate, where C<0.

16. The device of claim 15 wherein the rate control module is configured to perform the following additional step:
selecting the rate rₙ₊₁ that satisfies the optimal cost function for the second communication terminal as the optimal one of the plurality of rates to be used by the first communication terminal for the subsequent signal, where rₙ₊₁ is given by:
$${r}_{n + 1} = {argmax}_{u} \{ R ( {s}_{n} , {r}_{n} , u ) + β {V}_{n - 1} ( {s}_{n} , u ) \} .$$

17. The device of claim 11 further comprising a state determination module coupled to the rate control module and configured to perform the following step:
determining the channel state of the forward channel between the first communication terminal and the second communication terminal, the channel state based upon a measured signal-to-interference ratio corresponding to the received signal.

18. The device of claim 11 further comprising a receiver of the second communication terminal and configured to perform the following step:
receiving the received signal from the first communication terminal via the forward channel.

19. The device of claim 11 further comprising a transmitter coupled to the rate control module and configured to perform, the following step:
transmitting a respective rate update message to the first communication terminal, the rate update message indicating the optimal one of the plurality of rates to be used by the first communication terminal for the subsequent signal.

20. The device of claim 11 wherein the rate control module is located at the second communication terminal.

21. A method of rate control between a first communication terminal and a second communication terminal of a communication system, the method comprising:
obtaining a respective one of a plurality of rates corresponding to a signal received over a forward channel from the first communication terminal, the received signal having been modulated using the respective one of the plurality of rates, wherein each communication terminal is capable of supporting communications using the plurality of rates;
obtaining a channel state corresponding to the channel conditions of the forward channel for the signal received; and
determining an optimal one of the plurality of rates to be used by the first communication terminal for a subsequent signal to be transmitted to the second communication terminal based upon a maximization of the throughput to the second communication terminal given the channel state of the forward channel and a cost associated with a change in rate.

22. The method of claim 21 further comprising receiving, at the second communication terminal, the signal having been modulated with the respective one of the plurality of rates from the first communication terminal via the forward channel.

23. A rate control system between a first communication terminal and a second communication terminal, the system comprising:
means for receiving, at each of the one or more remote communication terminals, a respective signal modulated using a respective one of a plurality of rates from the first communication terminal via a respective forward channel, wherein each communication terminal is capable of supporting communications using the plurality of rates; and
means for determining a respective optimal one of the plurality of rates to be used by the first communication terminal for a respective subsequent signal to be transmitted to each of the one or more remote communication terminals based upon a respective maximization of the throughput to each of the one or more remote communication terminals given a respective channel state of each respective forward channel and a cost associated with a change in rate.
